(19) United States
(12) Patent Application Publication
(10) Pub. No.: US 2016/0275322 A1
(43) Pub. Date: Sep. 22, 2016

(54) UHF RFID WRIST STRAP

(71) Applicant: Thinkify LLC, Morgan Hill, CA (US)

(72) Inventor: Curtis L. Carrender, Morgan Hill, CA (US)

(21) Appl. No.: 15/071,706

(22) Filed: Mar. 16, 2016

Related U.S. Application Data
(60) Provisional application No. 62/133,640, filed on Mar. 16, 2015.

(51) Int. Cl. G06K 7/10; G06K 19/077

(52) U.S. Cl. CPC G06K 7/10366; G06K 19/07786; G06K 19/07762

(57) ABSTRACT

An RFID tag designed for the human wrist having a UHF beam powered transponder with an antenna that is formed without a resonator loop and configured to maximize a backscatter signal from the transponder when worn on the human wrist.

### BACKGROUND

1. Technical Field

The present disclosure is directed to a new design for a radio frequency identification tag that works in combination with a wrist strap.

2. Description of the Related Art

Radio Frequency Identification (RFID) technology operating at Ultra-High Frequencies (UHF) is now fairly well known. A typical RFID system includes a remote transponder or “tag” and a local interrogator or “reader.” The reader transmits an interrogation signal to the tag, which is received by the tag, modulated, and returned by backscatter reflection to the reader. The reader receives the modulated backscattered signal and extracts data, such as information about the tag or an object to which the tag is associated or about the location of the tag.

More particularly, modern UHF RFID tags are constructed by forming an antenna on a single RFID Application Specific Integrated Circuit (ASIC). The tag harvests energy from the electric field generated by the reader. The tag then modulates the match it has to the antenna, based upon code in the ASIC, resulting in a change in phase and or amplitude of the energy that is then reflected to the antenna of the interrogator. In the year 2015 it is estimated that over 6 billion UHF tags will be sold. These UHF tags are most often used for supply chain visibility.

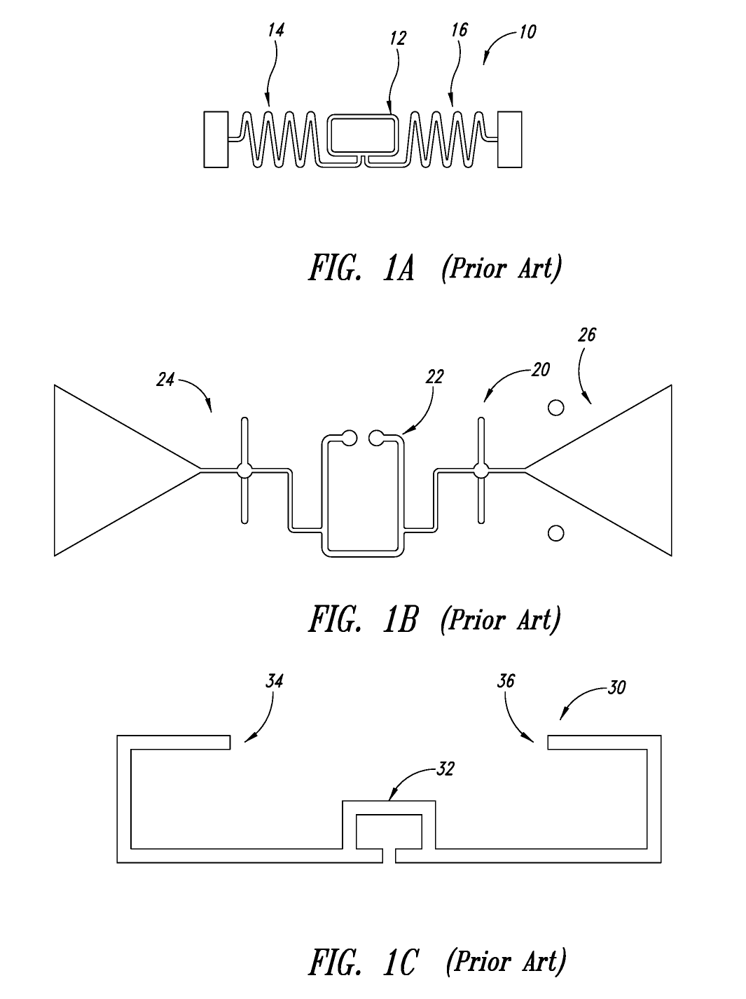

Referring to FIGS. 1A-1C, shown therein are three standard UHF RFID antennas 10, 20, 30, respectively. Each of these antennas 10, 20, 30, has a centrally located loop 12, 22, 32, respectively, coupled to first and second opposing antenna segments that are indicated with reference numbers 14, 16, in FIG. 1A, 24, 26 in FIG. 1B, and 34, 36 in FIG. 1C. The central loops 12, 22, 32 provide a substantial amount of inductance designed to counter out capacitance in the associated chip to which the antenna is coupled. The chip will almost always have some capacitance. When the inductance of this antenna loop 12, 22, 32 is put in parallel with the capacitance of the chip, it forms a resonant circuit.

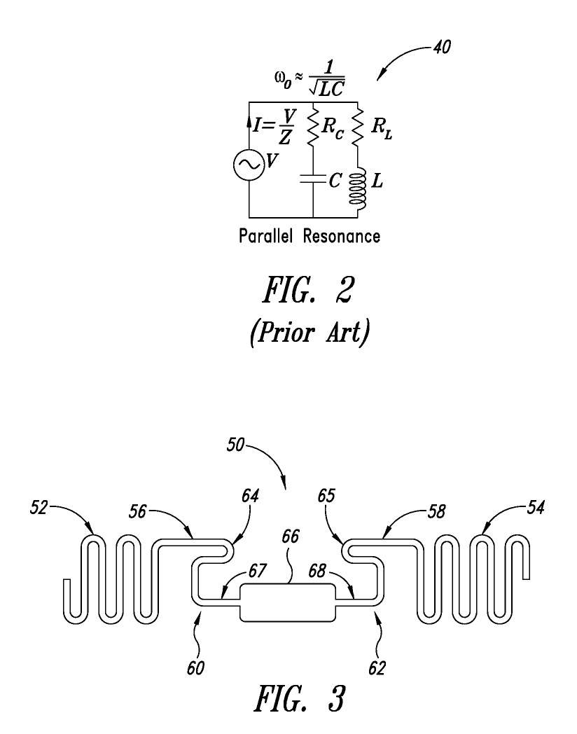

In FIG. 2 the circuit 40 illustrated is a schematic of a known RFID ASIC that has been modeled as a capacitor C. The associated antenna “loop” discussed above is modeled as the inductor L. In this model, the voltage V shown is the energy coming from the antenna. In these types of resonant circuits there is a peak voltage around the frequency defined as the maximum impedance at the resonant frequency. The resonant response in this circuit will generate a peak voltage to the chip to enable the chip to operate.

As discussed above, the majority of modern tags have such a loop structure, (again modeled by the inductance L above), as part of their design. There are many advantages to this type of design approach. This structure is tolerant of placement in that the resulting tag can work well on paper or plastic or even a table top. One disadvantage of this design is that the resulting backscatter obtained from the tag is reduced due to the effective shorting of the chip (not shown). In the example tag antennas 10, 20, 30 shown in FIGS. 1A-1C, it will be appreciated that whatever happens inside the associated chip, the antenna structure continues to be defined by the loop 12, 22, 32. This is because the loop 12, 22, 32 is basically a short across the chip. If the chip changes impedance as it modulates, it is basically still operating across a short. The main disadvantage of this type of match and this type of loop resonator tag design is that the resulting tag ends up with low backscatter.

Normally readers have sufficient gain to adjust for low backscatter, and the tag can still be read at any distance from which it can be powered on. This is not always the case with a tag positioned against or in close proximity to a conductor or absorber like a human body. Tags in these situations can be “on” but they may not be read due to low backscatter.

In many instances, the end user for an RFID system desires to track the movement of people. There is a long history of using UHF technology for this purpose, such as in timing of runners in races. Here the UHF tag is part of the runner's bib or on the user's shoe. This works well for race timing. As the tags are no longer tracing the runner after the individual changes clothes, (or shoes), this approach has a limited life. In the cases where an end user wants to track people for a longer period of time, there are some examples of wrist straps containing an RFID tag. In general these particular tags work poorly.

The human body can be modeled as a bag of salt water. Passive UHF tags, (the most affordable), require an electrical field to parasitically couple into so that they can derive their power. As the electrical field created by a UHF reader nears a conductive surface it goes to zero. Since by definition the UHF tags part of a wrist strap are very near the body, there is very little electrical field and therefore very little power for the tag. As a result the range of these wrist strap tags is very poor. For example, a tag that in free space has a range of 5 meters may have a range of less than 0.5 meters when placed near the wrist.

Hence, existing tags have very poor performance when used on or near the human body, particularly the wrist. In situations where it is desired to provide an easily attachable tag to the human wrist, there is a need for a tag and RFID system that can read the tag at greater distances than is possible with present technology.

### BRIEF SUMMARY

The present disclosure is directed to an RFID tag capable of operating at UHF frequencies, generally considered to be 800 MHz to 1200 MHz, and that is designed to operate on or very near the human wrist. Following is a summary of its' main characteristics.

The tag is designed without a resonator loop and uses a serial match. In the present disclosure, the input impedance of the chip can be matched using a serial inductance when using the antenna alone and not requiring a loop around the ASIC. This has two advantages for a wrist mounted tag. First the tag has a great deal more backscatter. As discussed above, backscatter amplitude is the amount of reflected energy from the tag that reaches the reader. When the tag ASIC has a resonator loop it is essentially “shorted.” The tag creates backscatter by changing its' internal impedance. If this impedance change is in parallel with a shorted resonator, the resulting change seen at the reader is small. When the circuit combines this type of modulation with the very low electrical field near the human body, the energy of the backscatter is lowered to the level that the tag cannot be seen by the reader. Indeed this is one of the failure types often seen with wrist type UHF tags. In these cases the tag is “on” but the backscatter level is so low that it cannot be detected.

In accordance with a second implementation, the tag is designed to have part of the antenna located away from the wrist in a type of “French Cuff” configuration. This configuration places a portion of the antenna above or away from the human body and increases the range of backscatter at which the tag operates. These two implementations of the tag increase usable read range dramatically for a wrist mounted UHF passive tag.

In accordance with a further aspect of the present disclosure, an RFID tag designed for the human wrist is provided. The tag includes a UHF beam powered transponder having an antenna that is formed without a resonator loop and configured to maximize a backscatter signal from the transponder when worn on the human wrist.

In accordance with another aspect of the present disclosure, the tag is carried by a wrist band configured to be worn on the human wrist, the tag including an antenna on the wrist band, and the wrist band having first and second terminal ends that each include a portion of the antenna and that are joined on a same side to create a tab containing the antenna extending 4 inches or less from a remainder of the wrist band and the human wrist when worn on the human wrist.

In accordance with yet a further aspect of the present disclosure, a device for use on the human wrist is provided that includes a radio frequency communication circuit operative to receive an interrogation signal and to backscatter a responsive signal, the radio frequency communication circuit having an input impedance; and an antenna without a resonator loop and coupled to the radio frequency communication circuit, the antenna sized and shaped to provide a serial inductance to match the input impedance of the radio frequency communication circuit and increase backscatter amplitude over backscatter amplitude of an antenna having a resonator loop when the device is worn on the human wrist.

In accordance with another aspect of the present disclosure, the foregoing device includes a band sized and shaped to be work on the human wrist and to carry the antenna and the radio frequency communication circuit, the band having first and second terminal ends that each include a portion of the antenna, the terminal ends configured to be attached together and extend the terminal ends of the band and the respective portions of the antenna 4 inches or less away from a remainder of the band and the human wrist.

In accordance with still yet another aspect of the present disclosure, a system is provided that includes a radio frequency interrogator configured to transmit an interrogation signal and to receive a backscatter signal in response to the interrogation signal; and a device for use on the human wrist, the device including: a radio frequency communication circuit operative to receive an interrogation signal and to backscatter a responsive signal, the radio frequency communication circuit having an input impedance and a capacitance; and an antenna without a resonator loop and coupled to the radio frequency communication circuit, the antenna sized and shaped to provide a serial inductance to match the input impedance of the radio frequency communication circuit and increase backscatter amplitude over backscatter amplitude of an antenna having a resonator loop when the device is worn on the human wrist.

In accordance with a further aspect of the foregoing system, the band and the first and second terminal ends have a substantially flat, planar shape with first and second opposing flat surfaces, the first flat surface of the first and second terminal ends configured to be attached together and form a projection containing the antenna that extends 4 inches or less away from a remainder of the band and the human wrist.

### BRIEF DESCRIPTION OF THE SEVERAL VIEWS OF THE INVENTION

The foregoing features and advantages of the present disclosure will be more readily appreciated as the same become better understood from the following detailed description when taken in conjunction with the accompanying drawings, wherein:

FIGS. 1A-1C illustrate three types of known tag antennas that utilize a resonator loop structure;

FIG. 2 is a schematic illustration of a known circuit in which the antenna resonator loop is modeled;

FIG. 3 illustrates an antenna configuration formed in accordance with the present disclosure without a resonator loop;

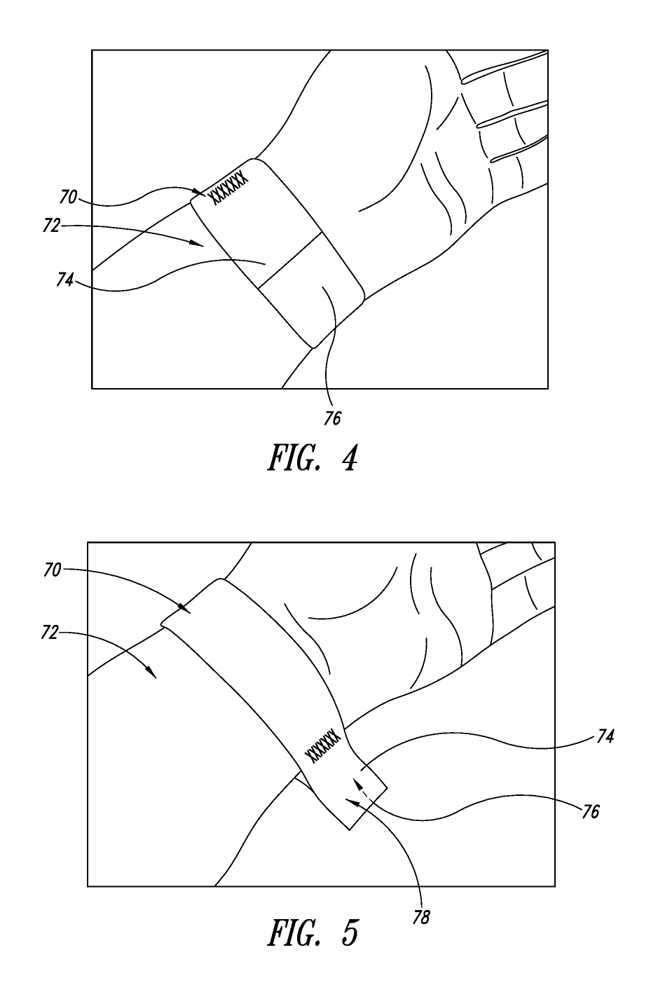

FIG. 4 illustrates an RFID tag implemented in the form of a wrist strap in accordance with the present disclosure;

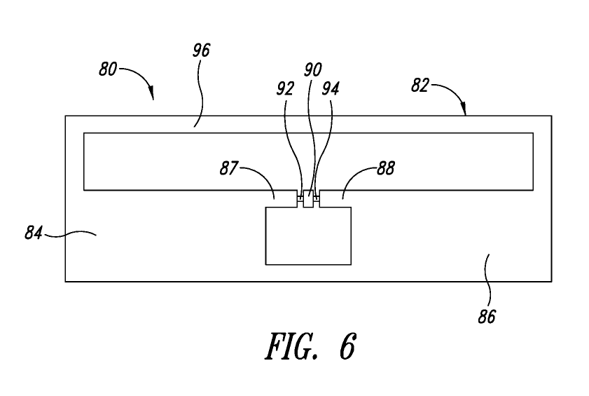

FIG. 5 illustrates an RFID tag implemented in the form of a wrist tag in which an added antenna area is formed in a French cuff type configuration; and

FIG. 6 illustrates another implementation of an RFID tag in the form of a wrist strap in accordance with the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with wrist straps, UHF readers, charging stations, and radio frequency transponders have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

When an electrical field, such as a transmitted signal, approaches the surface of a conductor, its energy will decrease to zero as it reverses phase and direction. There is no electrical field at the surface because this is the exact location of the reversal point. Because of this, a standard RFID UHF supply chain tag, (like any of the above), should not be placed on a metal surface. While the human body is not a perfect conductor or absorber, it can be poorly modeled as a conductor. It is certainly enough of a reflector that the microwave sensed doors open at the grocery store. Here the “reader” is a microwave source that senses reflection from a person or object within its field and triggers the door mechanism to open. The human body reflects a great deal of the energy back to the reader above the door and thus presence is sensed.

An RFID tag on or near the human wrist presents a difficult design problem in two ways. First, there is little reflected energy on or near the human wrist to begin with.

Second, the backscatter created, which as referenced above is already very small under the best circumstances, is greatly reduced by the amount of energy available to reflect back to the reader.

In the design of the present disclosure, the use of a non-loop or non-resonator tag greatly improves the modulation index of the tag and greatly increases the reflected signal back to the reader from the tag. A difficulty with non-resonator tags is it requires they have a more complicated structure than a loop tag. If they are made without structures to compensate for the capacitance of the RFID chip, they will not work well.

Another, perhaps even larger, disadvantage of non-resonator tags is that the match to the antenna is more perturbed by the surrounding environment in which the tag is used. A tag or label maker usually has no idea where the end product will be utilized. Will the tag be placed on wet wood, dry concrete, dense plastic, motor oil, or some other hostile environment? Each of these locations has a completely different dielectric constant and thus each affects the match to the tag differently. If the tag designer has used a loop resonator to match the ASIC, the resulting tag is less de-tuned by the various surroundings. In contrast, a serial match tag, (one without a loop resonator), is much more affected by its surroundings.

In the case of a dedicated wrist tag formed in accordance with the present disclosure, the tag is tuned specifically for the human wrist. This tag works poorly compared to a standard loop resonator tag when placed on most other items. To the inventor's knowledge, all previous wrist tags at UHF frequencies have been based on a standard supply chain tag that is simply placed in or on an existing wrist band.

Referring to FIG. 3, shown therein is a top plan view of the layout of a representative design for a serial match tag 50, i.e., one without a resonator loop, which is formed in accordance with the present disclosure. More particularly, the tag antenna 50 includes first and second opposing distal ends 52, 54, typically conductive tracings having a substantially serpentine shape. Each end 52, 54 has a proximal connection terminal 56, 58 that is electrically coupled to a central U-shaped section 60, 62, respectively. In this design, the central sections have first and second input terminals 64, 65 that are coupled to a respective connection terminal 56, 58 and output terminals 67, 68 coupled to a center section that includes an RFID ASIC 66.

In this design, there is no loop electrically connecting the first and second input terminals 64, 65 together. This tag is tuned for operation close to or on the human wrist by creating a serial resonant structure.

This tag 50 is configured to be worn as a wrist strap 70 as shown in FIG. 4, where it is worn on the human wrist 72. Here, the strap 70 has the tag 50 integrally formed therewith. However, it may be attached to the strap externally such as being separately formed and attached to the strap with adhesive, tape, or other non-electrical fastening substance or device or even by thermal bonding. The ends 74, 76 of the strap 70 are coupled together with known means, including without limitation adhesive, hook-and-loop fasteners, and snaps. The particular means chosen will depend on the desired longevity of the fastening of the ends 74, 76 together. With adhesive, the adhesive parts actually connect to opposing sides of the wrist strap.

FIG. 5 illustrates a second embodiment of the present disclosure in which the ends 74, 76 of the strap 70 are connected together to form a small tab 78 that is located or positioned away from the wrist 72. Ideally the tab extends 4 inches or less from a remainder of the wrist band, and it extends 4 inches or less from the human wrist when worn on the human wrist. Within the tab 72 are a portion of the distal ends 52, 54 of the antenna that is configured to increase effective operation of the tag antenna. The strap 70 has the ends 74, 76 joined by having adhesive formed on the same side of the strap ends 74, 76.

In accordance with one aspect of the present disclosure, the RFID tag 50 is designed to be destroyed upon de-lamination of the sticky part on the ends 74, 76. At a minimum, the portions of the distal ends 52, 54 of the antenna will be destroyed or deformed and rendered inoperable. Alternatively, the portions of the antenna 52, 54 will be disconnected from the remainder of the tag upon delamination.

Having this “French Cuff” type of approach greatly improves the tag's operational range and backscatter. It is to be understood that the “French Cuff” design can be implemented with a standard resonator loop tag to obtain enhanced range performance.

In accordance with the foregoing, a system is provided that includes a radio frequency interrogator configured to transmit an interrogation signal and to receive a backscatter signal in response to the interrogation signal. The band described above is designed for use on the human wrist and includes a radio frequency communication circuit operative to receive an interrogation signal and to backscatter a responsive signal. The radio frequency communication circuit has an input impedance and a capacitance. An antenna without a resonator loop is coupled to the radio frequency communication circuit, with the antenna sized and shaped to provide a serial inductance to match the input impedance of the radio frequency communication circuit, as well as to increase backscatter amplitude over backscatter amplitude of an antenna having a resonator loop, when the device is worn on the human wrist.

Ideally, the first and second terminal ends of the band have a substantially flat, planar shape with first and second opposing flat surfaces. The first flat surface of the first and second terminal ends are configured to be attached together and form a projection containing the antenna that extends 4 inches or less away from a remainder of the band and the human wrist as described above.

FIG. 6 illustrates a top plan view of the layout of another implementation of a UHF RFID tag 80 with a new closed loop dipole antenna design for use in close proximity to the human body. As shown, the tag 80 includes a dipole antenna 82 having first and second opposing distal ends 84, 86 typically conductive tracings having a substantially rectangular shape. Each end 84, 86 has a proximal connection terminal 87, 88 that is electrically coupled to an RFID ASIC 90 having first and second input terminals 92, 94. The dipole ends 84, 86 are electrically connected together by a conductor 96 that is formed parallel to the electric field of the antenna 82. This closed loop dipole antenna 82 can be used against the human body in any location, including the wrist.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An RFID tag designed for the human wrist, comprising: a UHF beam powered transponder having an antenna that is formed without a resonator loop and configured to maximize a backscatter signal from the transponder when worn on the human wrist.

2. The tag of claim 1 wherein the tag is carried by a wrist band configured to be worn on the human wrist, the tag including an antenna on the wrist band, and the wrist band having first and second terminal ends that each include a portion of the antenna and that are joined on a same side to create a tab containing the antenna extending 4 inches or less from a remainder of the wrist band and the human wrist when worn on the human wrist.

3. A device for use on the human wrist, comprising:
a radio frequency communication circuit operative to receive an interrogation signal and to backscatter a responsive signal, the radio frequency communication circuit having an input impedance; and
an antenna without a resonator loop and coupled to the radio frequency communication circuit, the antenna sized and shaped to provide a serial inductance to match the input impedance of the radio frequency communication circuit and increase backscatter amplitude over backscatter amplitude of an antenna having a resonator loop when the device is worn on the human wrist.

4. The device of claim 3, further comprising a band sized and shaped to be work on the human wrist and to carry the antenna and the radio frequency communication circuit, the band having first and second terminal ends that each include a portion of the antenna, the terminal ends configured to be attached together and extend the terminal ends of the band and the respective portions of the antenna 4 inches or less away from a remainder of the band and the human wrist.

5. A system, comprising:
a radio frequency interrogator configured to transmit an interrogation signal and to receive a backscatter signal in response to the interrogation signal; and
a device for use on the human wrist, the device including:
a radio frequency communication circuit operative to receive an interrogation signal and to backscatter a responsive signal, the radio frequency communication circuit having an input impedance and a capacitance; and
an antenna without a resonator loop and coupled to the radio frequency communication circuit, the antenna sized and shaped to provide a serial inductance to match the input impedance of the radio frequency communication circuit and increase backscatter amplitude over backscatter amplitude of an antenna having a resonator loop when the device is worn on the human wrist.

6. The system of claim 5 wherein the band and the first and second terminal ends have a substantially flat, planar shape with first and second opposing flat surfaces, the first flat surface of the first and second terminal ends configured to be attached together and form a projection containing the antenna that extends 4 inches or less away from a remainder of the band and the human wrist.
